(19) United States
(12) Patent Application Publication
(10) Pub. No.: US 2019/0251417 A1
(43) Pub. Date: Aug. 15, 2019

(54) Artificial Intelligence System for Inferring Grounded Intent

(71) Applicant: MICROSOFT TECHNOLOGY LICENSING, LLC, Redmond, WA (US)

(72) Inventors: Paul N Bennett, Redmond, WA (US); Marcello Mendes Hasegawa, Bothell, WA (US); Nikrouz Ghotbi, Redmond, WA (US); Ryen William White, Woodinville, WA (US); Abhishek Jha, Sammamish, WA (US)

(21) Appl. No.: 15/894,913

(22) Filed: Feb. 12, 2018

(51) Int. Cl. G06N 3/00; G06N 5/04; G06N 99/00

(52) U.S. Cl. CPC G06N 3/006; G06N 99/005; G06N 5/043

(57) ABSTRACT

Techniques for enabling an artificial intelligence system to infer grounded intent from user input, and automatically suggest and/or execute actions associated with the predicted intent. In an aspect, core task descriptions are extracted from actionable statements identified as containing grounded intent. A machine classifier receives the core task description, actionable statements, and user input to predict an intent class for the user input. The machine classifier may be trained using unsupervised learning techniques based on weakly labeled clusters of the core task description extracted over a training corpus. The core task description may include verb-object pairs.

### BACKGROUND

Modern personal computing devices such as smartphones and personal computers increasingly have the capability to support complex computational systems, such as artificial intelligence (AI) systems for interacting with human users in novel ways. One application of AI is to intent inference, wherein a device may infer certain types of user intent (known as “grounded intent”) by analyzing the content of user communications, and further take relevant and timely actions responsive to the inferred intent without requiring the user to issue any explicit commands.

The design of an AI system for intent inference requires novel and efficient processing techniques for training and implementing machine classifiers, as well as techniques for interfacing the AI system with agent applications to execute external actions responsive to the inferred intent.

### BRIEF DESCRIPTION OF THE DRAWINGS

FIG. 1 illustrates an exemplary embodiment of the present disclosure, wherein User A and User B participate in a messaging session using a chat application.

FIG. 2 illustrates an alternative exemplary embodiment of the present disclosure, wherein a user composes an email message using an email client on a device.

FIG. 3 illustrates an alternative exemplary embodiment of the present disclosure, wherein a user engages in a voice conversation with a digital assistant running on a device.

FIG. 4 illustrates exemplary actions that may be taken by a digital assistant responsive to the scenario of FIG. 1 according to the present disclosure.

FIG. 5 illustrates an exemplary embodiment of a method for processing user input to identify intent-to-perform task statements, predict intent, and/or suggest and execute actionable tasks according to the present disclosure.

FIG. 6 illustrates an exemplary embodiment of an artificial intelligence (AI) module for implementing the method of FIG. 5.

FIG. 7 illustrates an exemplary embodiment of a method for training a machine classifier to predict an intent class of an actionable statement given various input features.

FIGS. 8A, 8B, and 8C collectively illustrate an exemplary instance of training according to the method of FIG. 7, illustrating certain aspects of the present disclosure.

FIG. 9 illustratively shows other clusters and labeled intents that may be derived from processing corpus items in the manner described.

FIG. 10 illustrates an exemplary embodiment of a method according to the present disclosure.

FIG. 11 illustrates an exemplary embodiment of an apparatus according to the present disclosure.

FIG. 12 illustrates an alternative exemplary embodiment of an apparatus according to the present disclosure.

### DETAILED DESCRIPTION

Various aspects of the technology described herein are generally directed towards techniques for inferring grounded intent from user input to a digital device. In this Specification and in the Claims, a grounded intent is a user intent which gives rise to a task (herein “actionable task”) for which the device is able to render assistance to the user. An actionable statement refers to a statement of an actionable task.

In an aspect, an actionable statement is identified from user input, and a core task description is extracted from the actionable statement. A machine classifier predicts an intent class for each actionable statement based on the core task description, user input, as well as other contextual features. The machine classifier may be trained using supervised or unsupervised learning techniques, e.g., based on weakly labeled clusters of core task descriptions extracted from a training corpus. In an aspect, clustering may be based on textual and semantic similarity of verb-object pairs in the core task descriptions.

The detailed description set forth below in connection with the appended drawings is intended as a description of exemplary means “serving as an example, instance, or illustration,” and should not necessarily be construed as preferred or advantageous over other exemplary aspects. The detailed description includes specific details for the purpose of providing a thorough understanding of the exemplary aspects of the invention. It will be apparent to those skilled in the art that the exemplary aspects of the invention may be practiced without these specific details. In some instances, well-known structures and devices are shown in block diagram form in order to avoid obscuring the novelty of the exemplary aspects presented herein.

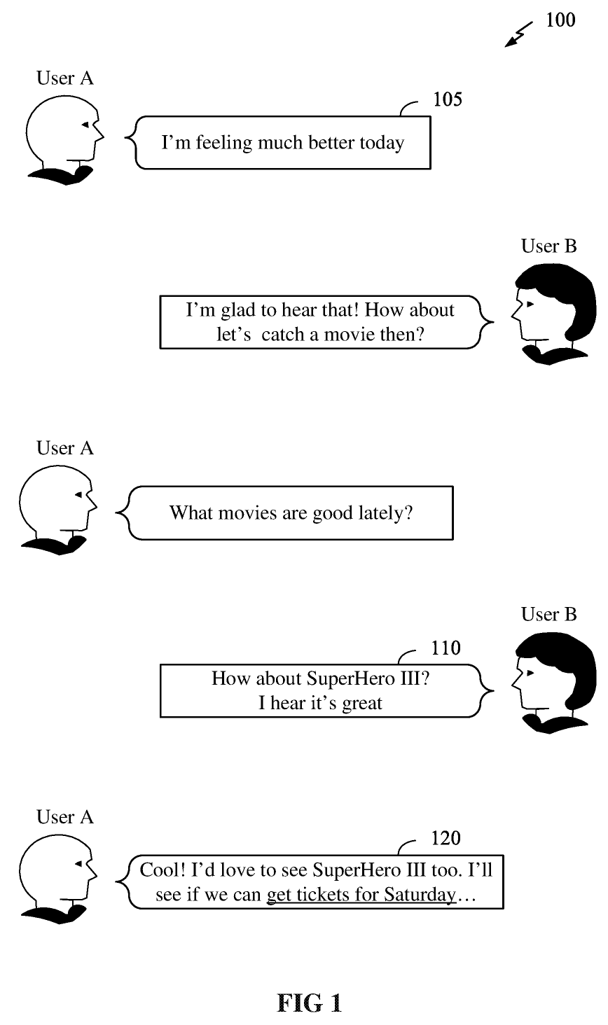

FIGS. 1, 2, and 3 illustrate exemplary embodiments of the present disclosure. Note the embodiments are shown for illustrative purposes only, and are not meant to limit the scope of the present disclosure to any particular applications, scenarios, contexts, or platforms to which the disclosed techniques may be applied.

FIG. 1 illustrates an exemplary embodiment of the present disclosure, wherein User A and User B participate in a digital messaging session 100 using a personal computing device (herein “device,” not explicitly shown in FIG. 1), e.g., smartphone, laptop or desktop computer, etc. Referring to the contents of messaging session 100, User A and User B engage in a conversation about seeing an upcoming movie. At 110, User B suggests seeing the movie “SuperHero III.” At 120, User A offers to look into acquiring tickets for a Saturday showing of the movie.

At this juncture, to follow through on the intent to acquire tickets, User A may normally disengage momentarily from the chat session and manually execute certain other tasks, e.g., open a web browser to look up movie showtimes, or open another application to purchase tickets, or call the movie theater, etc. User A may also configure his device to later remind him of the task of purchasing tickets, or to set aside time on his calendar for the movie showing.

In the aforementioned scenario, it would be desirable to provide capabilities to the device (either that of User A or User B) to, e.g., automatically identify the actionable task of retrieving movie ticket information from the content of messaging session 100, and/or automatically execute any associated tasks such as purchasing movie tickets, setting reminders, etc.

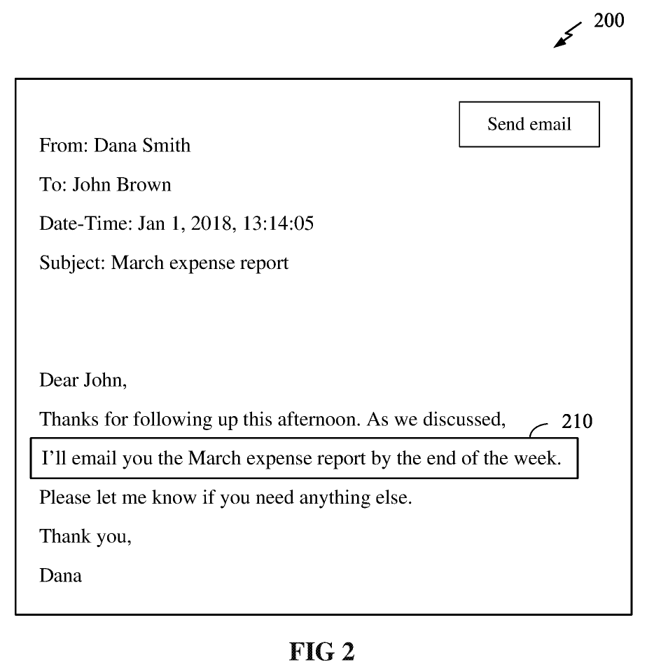

FIG. 2 illustrates an alternative exemplary embodiment of the present disclosure, wherein a user composes and prepares to send an email message using an email client on a device (not explicitly shown in FIG. 2). Referring to the contents of email 200, the sender (Dana Smith) confirms to a recipient (John Brown) at statement 210 that she will be emailing him a March expense report by the end of week. After sending the email, Dana may, e.g., open a word processing and/or spreadsheet application to edit the March expense report. Alternatively, or in addition, Dana may set a reminder on her device to perform the task of preparing the expense report at a later time.

In this scenario, it would be desirable to provide capabilities to Dana's device to identify the presence of an actionable task in email 200, and/or automatically launch the appropriate application(s) to handle the task. Where possible, it may be further desirable to launch the application(s) with appropriate template settings, e.g., an expense report template populated with certain data fields specifically tailored to the month of March, or to the email recipient, based on previously prepared reports, etc.

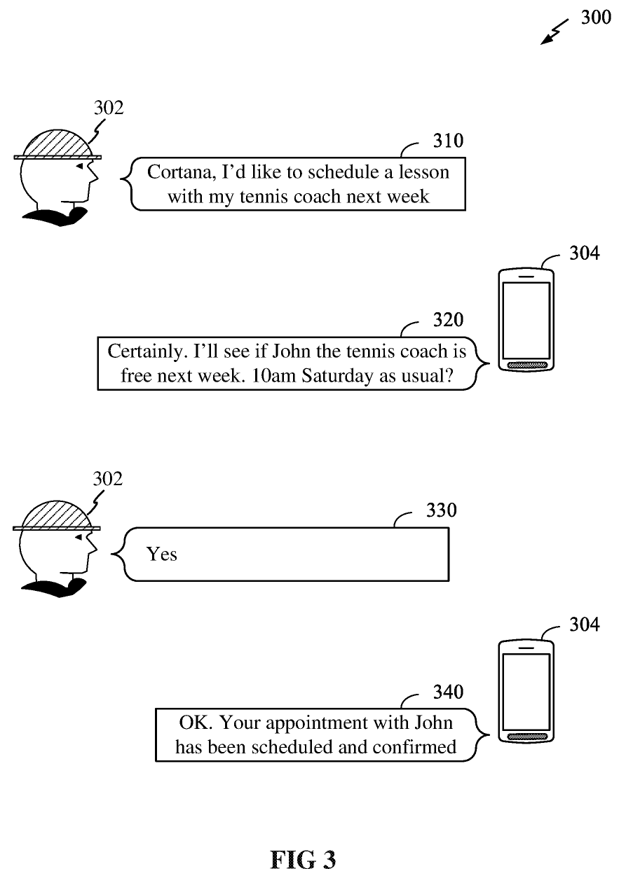

FIG. 3 illustrates an alternative exemplary embodiment of the present disclosure, wherein a user 302 engages in a voice conversation 300 with a digital assistant (herein “DA”) being executed on device 304. In an exemplary embodiment, the DA may correspond to, e.g., the Cortana digital assistant from Microsoft Corporation. Note in FIG. 3, the text shown may correspond to the content of speech exchanged between user 302 and the DA. Further note that while an explicit request is made to the DA in conversation 300, it will be appreciated that techniques of the present disclosure may also be applied to identify actionable statements from user input not explicitly directed to a DA or to the intent inference system, e.g., as illustrated by messaging session 100 and email 200 described hereinabove, or other scenarios.

Referring to conversation 300, user 302 at block 310 may explicitly request the DA to schedule a tennis lesson with the tennis coach next week. Based on the user input at block 310, DA 304 identifies the actionable task of scheduling a tennis lesson, and confirms details of the task to be performed at block 320.

To execute the task of making an appointment, DA 304 is further able to retrieve and perform the specific actions required. For example, DA 304 may automatically launch an appointment scheduling application on the device (not shown) to schedule and confirm the appointment with the tennis coach John. Execution of the task may further be informed by specific contextual parameters available to DA 304, e.g., the identity of the tennis coach as garnered from previous appointments made, a suitable time for the lesson based on the user's previous appointments and/or the user's digital calendar, etc.

From conversation 300, it will be appreciated that an intent inference system may desirably supplement and customize any identified actionable task with implicit contextual details, e.g., as may be available from the user's cumulative interactions with the device, parameters of the user's digital profile, parameters of a digital profile of another user with whom the user is currently communicating, and/or parameters of one or more cohort models as further described hereinbelow. For example, based on a history of previous events scheduled by the user through the device, certain additional details may be inferred about the user's present intent, e.g., regarding the preferred time of the tennis lesson to be scheduled, preferred tennis instructor, preferred movie theaters, preferred applications to use for creating expense reports, etc.

In an illustrative aspect, theater suggestions may further be based on a location of the device as obtained from, e.g., a device geolocation system, or from a user profile, and/or also preferred theaters frequented by the user as learned from scheduling applications or previous tasks executed by the device. Furthermore, contextual features may include the identity of a device from which the user communicates with an AI system. For example, appointments scheduled from a smartphone device may be more likely to be personal appointments, while those scheduled from a personal computer used for work may be more likely to be work appointments.

In an exemplary embodiment, cohort models may also be used to inform the intent inference system. In particular, a cohort model corresponds to one or more profiles built for users similar to the current user along one or more dimensions. Such cohort models may be useful, e.g., particularly when information for a current user is sparse, due to the current user being newly added or other reasons.

In view of the foregoing examples, it would be desirable to provide capabilities to a device running an AI system to identify the presence of actionable statements from user input, to classify the intent behind the actionable statements, and further to automatically execute specific actions associated with the actionable statements. It would be further desirable to infuse the identification and execution of tasks with contextual features as may be available to the device, and to accept user feedback on the classified intents, to increase the relevance and accuracy of intent inference and task execution.

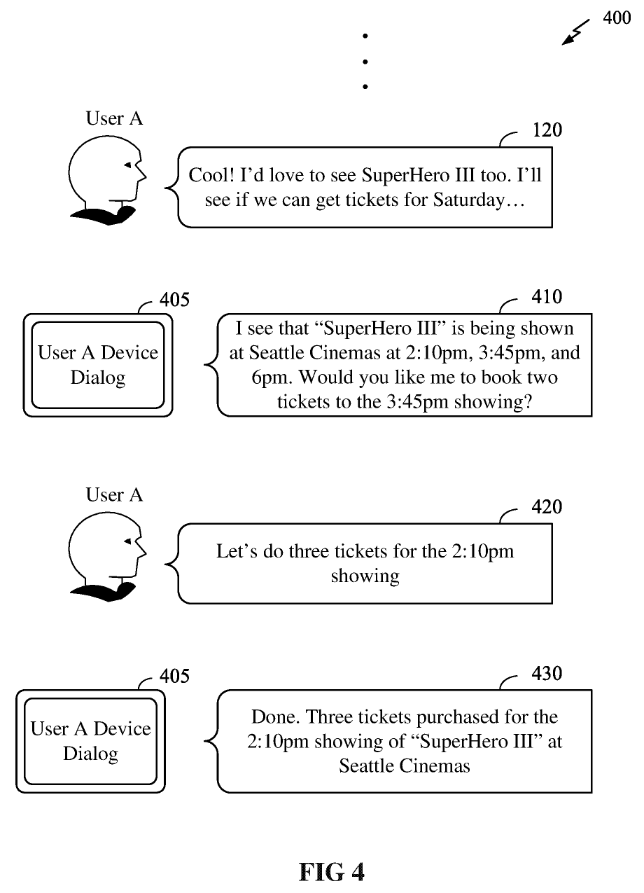

FIG. 4 illustrates exemplary actions that may be performed by an AI system responsive to scenario 100 according to the present disclosure. Note FIG. 4 is shown for illustrative purposes only, and is not meant to limit the scope of the present disclosure to any particular types of applications, scenarios, display formats, or actions that may be executed.

In particular, following User A's input 120, User A's device may display a dialog box 405 to User A, as shown in FIG. 4. In an exemplary embodiment, the dialog box may be privately displayed at User A's device, or the dialog box may be alternatively displayed to all participants in a conversation. From the content 410 of dialog box 405, it is seen that the device has inferred various parameters of User A's intent to purchase movie tickets based on block 120, e.g., the identity of the movie, possible desired showing times, a preferred movie theater, etc. Based on the inferred intent, the device may have proceeded to query the Internet for local movie showings, e.g., using dedicated movie ticket booking applications, or Internet search engines such as Bing. The device may further offer to automatically purchase the tickets pending further confirmation from User A, and proceed to purchase the tickets, as indicated at blocks 420, 430.

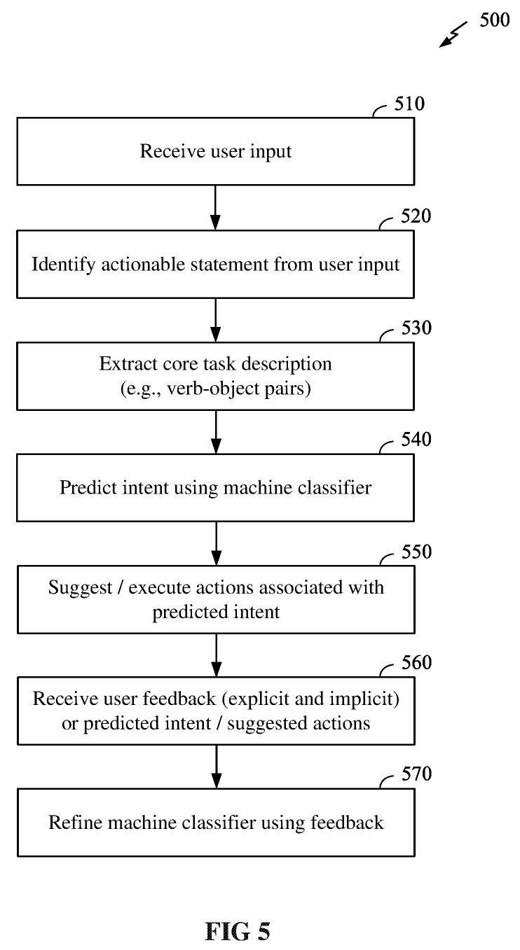

FIG. 5 illustrates an exemplary embodiment of a method 500 for processing user input to identify intent-to-perform task statements, predict intent, and/or suggest and execute actionable tasks according to the present disclosure. It will be appreciated that method 500 may be executed by an AI system running on the same device or devices used to support the features described hereinabove with reference to FIGS. 1-4, or on a combination of the device(s) and other online or offline computational facilities.

In FIG. 5, at block 510, user input (or “input”) is received. In an exemplary embodiment, user input may include any data or data streams received at a computing device through a user interface (UI). Such input may include, e.g., text, voice, static or dynamic imagery containing gestures (e.g., sign-language), facial expressions, etc. In certain exemplary embodiments, the input may be received and processed by the device in real-time, e.g., as the user generates and inputs the data to the device. Alternatively, data may be stored and collectively processed subsequently to being received through the UI.

At block 520, method 500 identifies the presence in the user input of one or more actionable statements. In particular, block 520 may flag one or more segments of the user input as containing actionable statements. Note in this Specification and in the Claims, the term “identify” or “identification” as used in the context of block 520 may refer to the identification of actionable statements in user input, and does not include predicting the actual intent behind such statements or associating actions with predicted intents, which may be performed at a later stage of method 500.

For example, referring to session 100 in FIG. 1, method 500 may identify an actionable statement at the underlined portion of block 120 of messaging session 100. The identification may be performed in real-time, e.g., while User A and User B are actively engaged in their conversation. Note the presence in session 100 of non-actionable statements (e.g., block 105) as well as actionable statements (e.g., block 120), and it will be understood that block 520 is designed to flag statements such as block 120 but not statements such as block 105.

In an exemplary embodiment, the identification may be performed using any of various techniques. For example, a commitments classifier for identifying commitments (i.e., a type of actionable statement) may be applied as described in U.S. patent application Ser. No. 14/714,109, filed May 15, 2015, entitled “Management of Commitments and Requests Extracted from Communications and Content,” and U.S. patent application Ser. No. 14/714,137, filed May 15, 2015, entitled “Automatic Extraction of Commitments and Requests from Communications and Content,” the disclosures of which are incorporated herein by reference in their entireties. In alternative exemplary embodiments, identification may utilize a conditional random field (CRF) or other (e.g. neural) extraction model on the user input, and need not be limited only to classifiers. In an alternative exemplary embodiment, a sentence breaker/chunker may be used to process user input such as text, and a classification model may be trained to identify the presence of actionable task statements using supervised or unsupervised labels. In alternative exemplary embodiments, request classifiers or other types of classifiers may be applied to extract alternative types of actionable statements. Such alternative exemplary embodiments are contemplated to be within the scope of the present disclosure.

At block 530, a core task description is extracted from the identified actionable statement. In an exemplary embodiment, the core task description may correspond to an extracted subset of symbols (e.g., words or phrases) from the actionable statement, wherein the extracted subset is chosen to aid in predicting the intent behind the actionable statement.

In an exemplary embodiment, the core task description may include a verb entity and an object entity extracted from the actionable statement, also denoted herein a “verb-object pair.” The verb entity includes one or more symbols (e.g., words) that captures an action (herein “task action”), while the object entity includes one or more symbols denoting an object to which the task action is applied. Note verb entities may generally include one or more verbs, but need not include all verbs in a sentence. The object entity may include a noun or a noun phrase.

The verb-object pair is not limited to combinations of only two words. For example, “email expense report” may be a verb-object pair extracted from statement 210 in FIG. 2. In this case, “email” may be the verb entity, and “expense report” may be the object entity. The extraction of the core task description may employ, e.g., any of a variety of natural language processing (NLP) tools (e.g. dependency parser, constituency tree+finite state machine), etc.

In an alternative exemplary embodiment, blocks 520 and 530 may be executed as a single functional block, and such alternative exemplary embodiments are contemplated to be within the scope of the present disclosure. For example, block 520 may be considered a classification operation, while block 530 may be considered a sub-classification operation, wherein intent is considered part of a taxonomy of activities. In particular, if the user commits to doing an action, then the sentence can be classified as a “commitment” at block 520, while block 530 may sub-classify the commitment as, e.g., an “intent to send email” if the verb-object pair corresponds to “send an email” or “send the daily update email.”

At block 540, a machine classifier is used to predict an intent underlying the identified actionable statement by assigning an intent class to the statement. In particular, the machine classifier may receive features such as the actionable statement, other segments of the user input besides and/or including the actionable statement, the core task description extracted at block 530, etc. The machine classifier may further utilize other features for prediction, e.g., contextual features including features independent of the user input, such as derived from prior usage of the device by the user or from parameters associated with a user profile or cohort model.

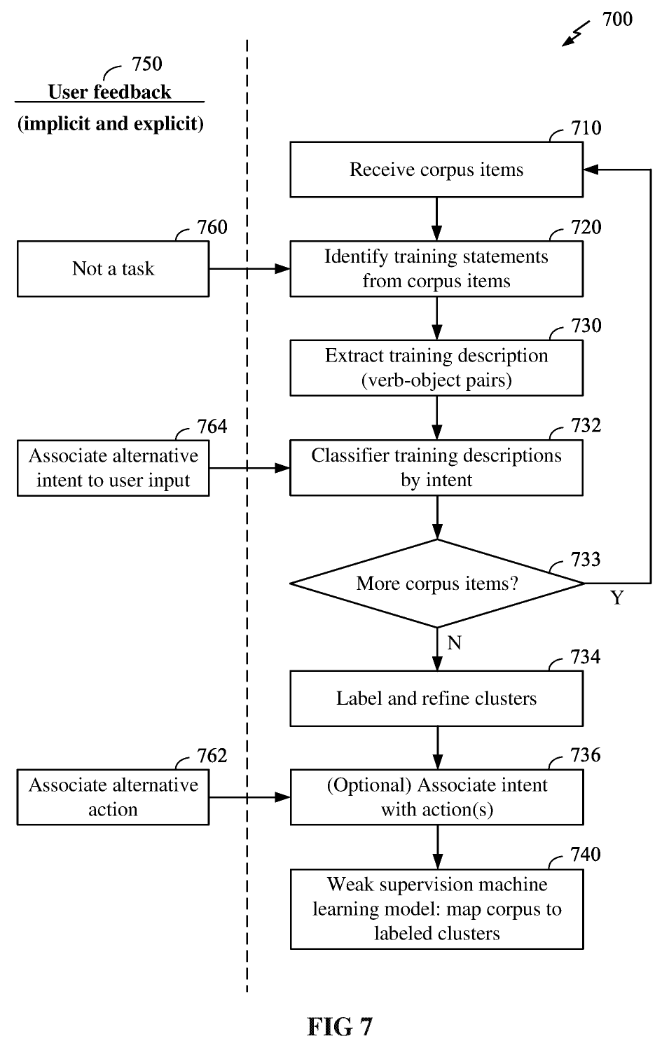

Based on these features, the machine classifier may assign the actionable statement to one of a plurality of intent classes, i.e., it may “label” the actionable statement with an intent class. For example, for messaging session 100, a machine classifier at block 540 may label User A's statement at block 120 with an intent class of “purchase movie tickets,” wherein such intent class is one of a variety of different possible intent classes. In an exemplary embodiment, the input-output mappings of the machine classifier may be trained according to techniques described hereinbelow with reference to FIG. 7.

At block 550, method 500 suggests and/or executes actions associated with the intent predicted at block 540. For example, the associated action(s) may be displayed on the UI of the device, and the user may be asked to confirm the suggested actions for execution. The device may then execute approved actions.

In an exemplary embodiment, the particular actions associated with any intent may be preconfigured by the user, or they may be derived from a database of intent-to-actions mappings available to the AI system. In an exemplary embodiment, method 500 may be enabled to launch and/or configure one or more agent applications on the computing device to perform associated actions, thereby extending the range of actions the AI system can accommodate. For example, in email 200, a spreadsheet application may be launched in response to predicting the intent of actionable statement 210 as the intent to prepare an expense report.

In an exemplary embodiment, once associated tasks are identified, the task may be enriched with the addition of an action link that connects to an app, service or skill that can be used to complete the action. The recommended actions may be surfaced through the UI in various manners, e.g., in line, or in cards, and the user may be invited to select one or more actions per task. Fulfillment of the selected actions may be supported by the AI system, and connections or links containing preprogrammed parameters are provided to other applications with the task payload. In an exemplary embodiment, responsibility for executing the details of ceratin actions may be delegated to agent application(s), based on agent capabilities and/or user preferences.

At block 560, user feedback is received regarding the relevance and/or accuracy of the predicted intent and/or associated actions. In an exemplary embodiment, such feedback may include, e.g., explicit user confirmation of the suggested task (direct positive feedback), feedback), user rejection of actions suggested by the AI system (diret negative feedback), or user selection of an alternative action or task from that suggested by the AI system (indirect negative feedback).

At block 570, user feedback obtained at block 560 may be used to refine the machine classifier. In an exemplary embodiment, refinement of the machine classifier may proceed as described hereinbelow with reference to FIG. 7.

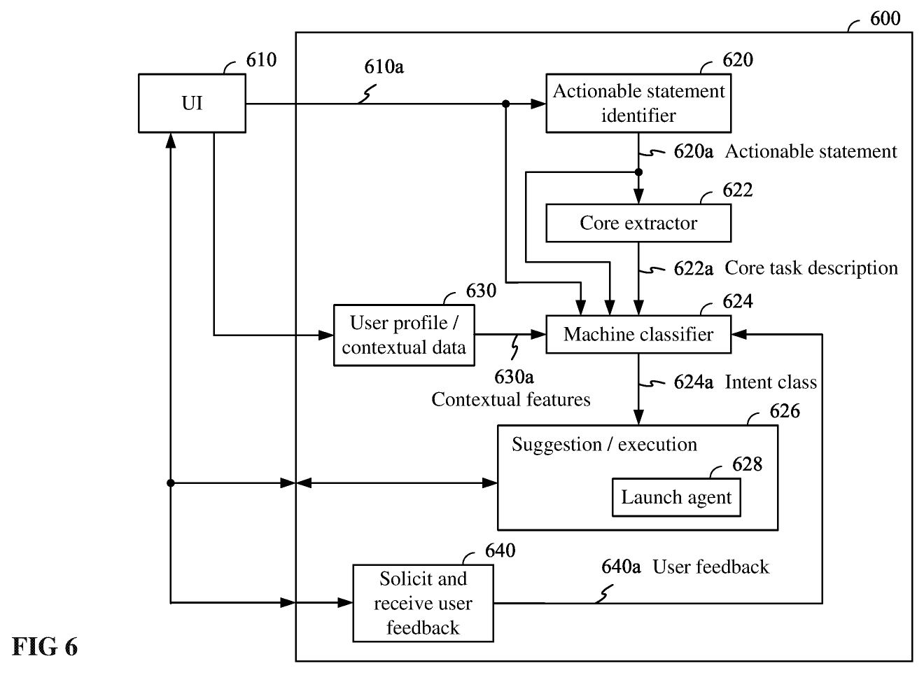

FIG. 6 illustrates an exemplary embodiment of an artificial intelligence (AI) module 600 for implementing method 500. Note FIG. 6 is shown for illustrative purposes only, and is not meant to limit the scope of the present disclosure.

In FIG. 6, AI module 600 interfaces with a user interface (UI) 610 to receive user input, and further output data processed by module 600 to the user. In an exemplary embodiment, AI module 600 and UI 610 may be provided on a single device, such as any device supporting the functionality described hereinabove with reference to FIGS. 1-4 hereinabove.

AI module 600 includes actionable statement identifier 620 coupled to UI 610. Identifier 620 may perform the functionality described with reference to block 520, e.g., it may receive user input and identify the presence of actionable statements. As output, identifier 620 generates actionable statement 620a corresponding to, e.g., a portion of the user input that is flagged as containing an actionable statement.

Actionable statement 620a is coupled to core extractor 622. Extractor 622 may perform the functionality described with reference to block 530, e.g., it may extract “core task description” 622a from the actionable statement. In an exemplary embodiment, core task description 622a may include a verb-object pair.

Actionable statement 620a, core task description 622a, and other portions of user input 610a may be coupled as input features to machine classifier 624. Classifier 624 may perform the functionality described with reference to block 540, e.g., it may predict an intent underlying the identified actionable statement 620a, and output the predicted intent as the assigned intent class (or “label”) 624a.

In an exemplary embodiment, machine classifier 624 may further receive contextual features 630a generated by a user profile/contextual data block 630. In particular, block 630 may store contextual features associated with usage of the device or profile parameters. The contextual features may be derived from the user through UI 610, e.g., either explicitly entered by user to set up a user profile or cohort model, or implicitly derived from interactions between the user and the device through UI 610. Contextual features may also be derived from sources other than UI 610, e.g., through an Internet profile associated with the user.

Intent class 624a is provided to task suggestion/execution block 626. Block 626 may perform the functionality described with reference to block 550, e.g., it may suggest and/or execute actions associated with the intent label 624a. Block 626 may include a sub-module 628 configured to launch external applications or agents (not explicitly shown in FIG. 6) to execute the associated actions.

AI module 600 further includes a feedback module 640 to solicit and receive user feedback 640a through UI 610. Module 640 may perform the functionality described with reference to block 560, e.g., it may receive user feedback regarding the relevance and/or accuracy of the predicted intent and/or associated actions. User feedback 640a may be used to refine the machine classifier 624, as described hereinbelow with reference to FIG. 7.

FIG. 7 illustrates an exemplary embodiment of a method 700 for training machine classifier 624 to predict the intent of an actionable statement based on various features. Note FIG. 7 is shown for illustrative purposes only, and is not meant to limit the scope of the present disclosure to any particular techniques for training a machine classifier.

At block 710, corpus items are received for training the machine classifier. In an exemplary embodiment, corpus items may correspond to historical or reference user input containing content that may be used to train the machine classifier to predict task intent. For example, any of items 100, 200, 300 described hereinabove may be utilized as corpus items to train the machine classifier. Corpus items may include items generated by the current user, or by other users with whom the current user has communicated, or other users with whom the current user shares commonalities, etc.

At block 720, an actionable statement (herein “training statement”) is identified from a received corpus item. In an exemplary embodiment, identifying training statements may be executed in the same or similar manner as described with reference to block 520 for identifying actionable statements.

At block 730, a core task description (herein “training description”) is extracted from each identified actionable statement. In an exemplary embodiment, extracting training descriptions may be executed in the same or similar manner as described with reference to block 530 for extracting core task descriptions, e.g., based on extraction of verb-object pairs.

At block 732, training descriptions are grouped into “clusters,” wherein each cluster includes one or more training descriptions adjudged to have similar intent. In an exemplary embodiment, text-based training descriptions may be represented using bag-of-words models, and clustered using techniques such as K-means. In alternative exemplary embodiments, any representations achieving similar functions may be implemented.

In exemplary embodiments wherein training descriptions include verb-object pairs, clustering may proceed in two or more stages, wherein pairs sharing similar object entities are grouped together at an initial stage. For instance, for the single object “email,” one can “write,” “send,” “delete,” “forward,” “draft,” “pass along,” “work on,” etc. Accordingly, in a first stage, all such verb-object pairs sharing the object “email” (e.g., “write email,” “send email,” etc.) may be grouped into the same cluster.

Thus at a first stage of clustering, the training descriptions may first be grouped into a first set of clusters based on textual similarity of the corresponding objects. Subsequently, at a second stage, the first set of clusters may be refined into a second set of clusters based on textual similarity of the corresponding verbs. The refinement at the second stage may include, e.g., reassigning training descriptions to different clusters from the first set of clusters, removing training descriptions from the first set of clusters, creating new clusters, etc.

Following block 732, it is determined whether there are more corpus items to process, prior to proceeding with training. If so, then method 700 returns to block 710, and additional corpus items are processed. Otherwise, the method proceeds to block 734. It will be appreciated that executing blocks 710-732 over multiple instances of corpus items results in the plurality of training descriptions being grouped into different clusters, wherein each cluster is associated with a distinct intent.

At block 734, each of the plurality of clusters may further be manually labeled or annotated by a human operator. In particular, a human operator may examine the training descriptions associated with each cluster, and manually annotate the cluster with an intent class. Further at block 734, the contents of each cluster may be manually refined. For example, if a human operator deems that one or more training descriptions in a cluster do not properly belong to that cluster, then such training descriptions may be removed and/or reassigned to another cluster. In some exemplary embodiments of method 700, manual evaluation at block 734 is optional.

At block 736, each cluster may optionally be associated with a set of actions relevant to the labeled intent. In an exemplary embodiment, block 736 may be performed manually, by a human operator, or by crowd-sourcing, etc. In an exemplary embodiment, actions may be associated with intents based on preferences of cohorts that the user belongs to or the general population.

At block 740, a weak supervision machine learning model is applied to train the machine classifier using features and corresponding labeled intent clusters. In particular, following blocks 710-736, each corpus item containing actionable statements will be associated with a corresponding intent class, e.g., as derived from block 734. The labeled intent classes are used to train the machine classifier to accurately map each set of features into the corresponding intent class. Note in this context, “weak supervision” refers to the aspect of the training description of each actionable statement being automatically clustered using computational techniques, rather than requiring explicit human labeling of each core task description. In this manner, weak supervision may advantageously enable the use of a large dataset of corpus items to train the machine classifier.

In an exemplary embodiment, features to the machine classifier may include derived features such as the identified actionable statement, and/or additional text taken from the context of the actionable statement. Features may further include training descriptions, related context from the overall corpus item, information from metadata of the communications corpus item, or information from similar task descriptions.

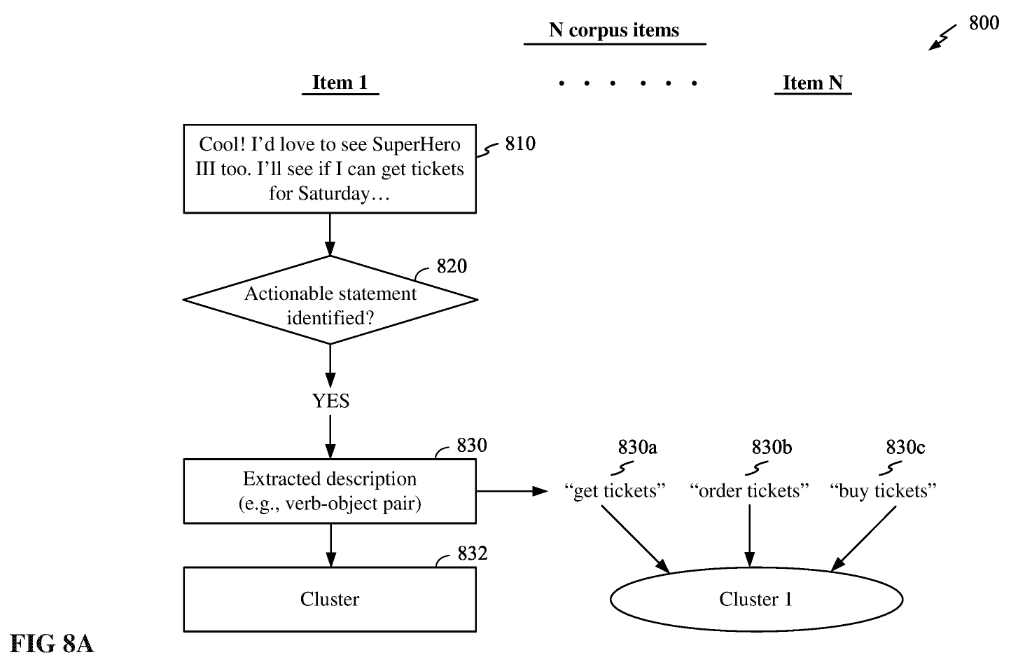

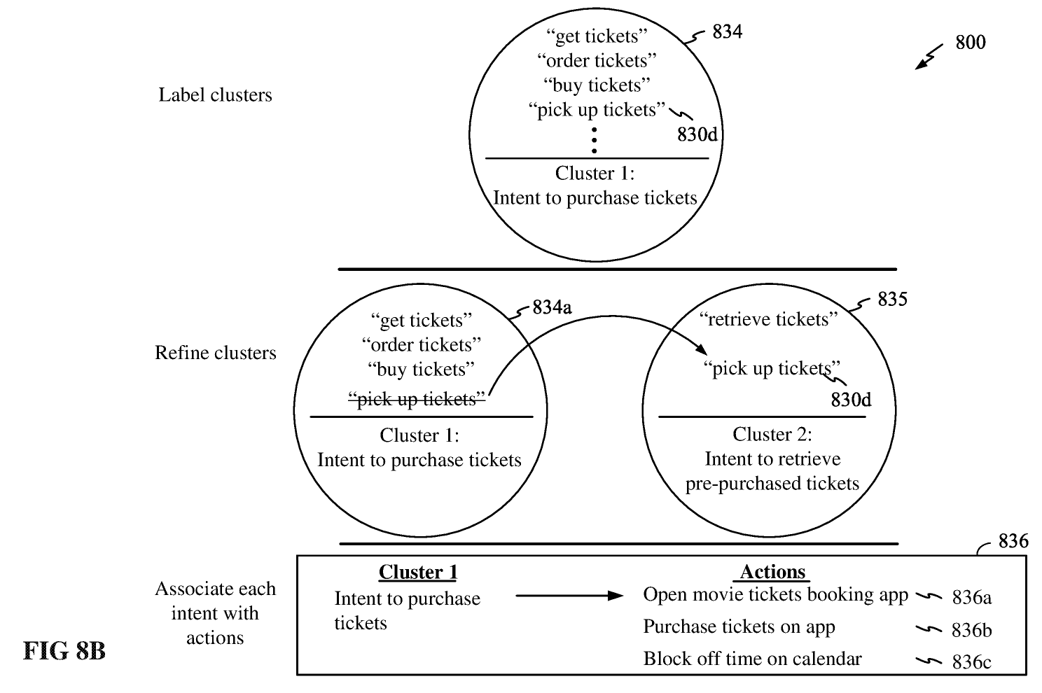

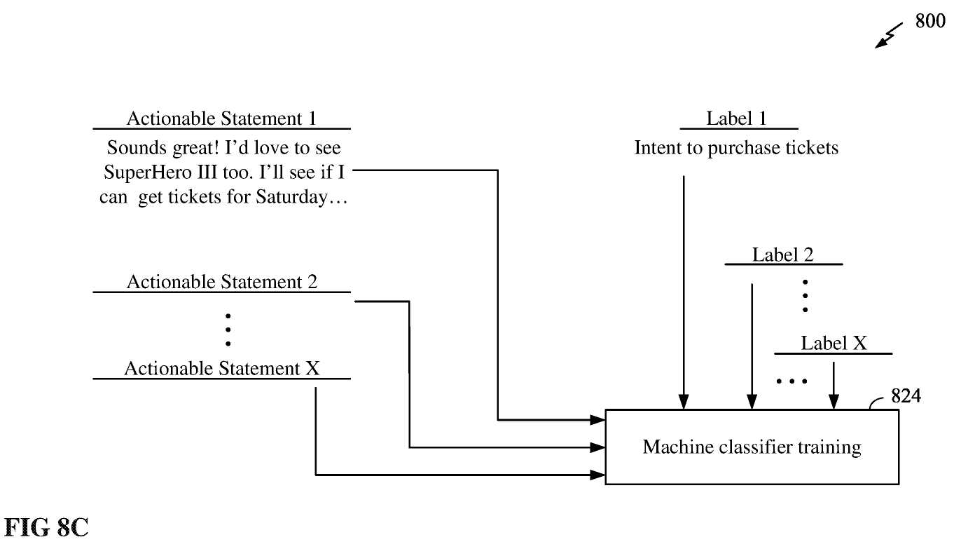

FIGS. 8A, 8B, and 8C collectively illustrate an exemplary instance of training according to method 700, illustrating certain aspects of the execution of method 700. Note FIGS. 8A, 8B, and 8C are shown for illustrative purposes only, and are not meant to limit the scope of the present disclosure to any particular instance of execution of method 700.

In FIG. 8A, a plurality N of sample corpus items received at block 710 are suggestively illustrated as “Item 1” through “Item N,” and only text 810 of the first corpus item (Item 1) is explicitly shown. In particular, text 810 corresponds to block 120 of messaging session 100, earlier described hereinabove, which is illustratively considered as a corpus item for training.

At block 820, the presence of an actionable statement is identified in text 810 from Item 1, as per training block 720. In the example, the actionable statement corresponds to the underlined sentence of text 810.

At block 830, a training description is extracted from the actionable statement, as per training block 730. In the exemplary embodiment shown, the training description is the verb-object pair “get tickets” 830a. FIG. 8A further illustratively shows other examples 830b, 830c of verb-object pairs that may be extracted from, e.g., other corpus items (not shown in FIG. 8A) containing similar intent to the actionable statement identified.

At block 832, training descriptions are clustered, as per training block 732. In FIG. 8A, the clustering techniques described hereinabove are shown to automatically identify extracted descriptions 830a, 830b, 830c as belonging to the same cluster, Cluster 1.

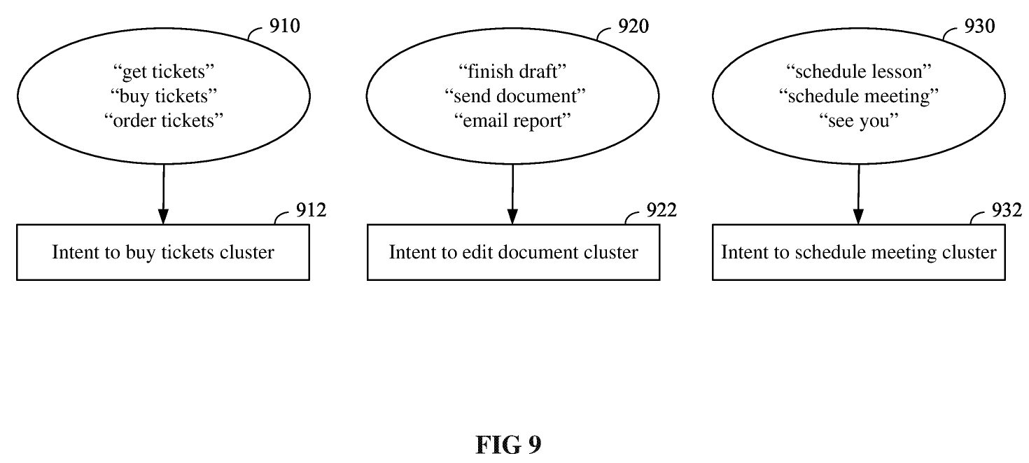

As indicated in FIG. 7, training blocks 710-732 are repeated over many corpus items. Cluster 1 (834) illustratively shows a resulting sample cluster containing four training descriptions, as per execution of training block 734. In particular, Cluster 1 is manually labeled with a corresponding intent. For example, inspection of the training descriptions in Cluster 1 may lead a human operator to annotate Cluster 1 with the label “Intent to purchase tickets,” corresponding to the intent class “purchase tickets.” FIG. 9 illustratively shows other clusters 910, 920, 930 and labeled intents 912, 922, 932 that may be derived from processing corpus items in the manner described.

Clusters 834a, 835 of FIG. 8B illustrates how the clustering may be manually refined, as per training block 734. For example, the training description “pick up tickets” 830d, originally clustered into Cluster 1 (834), may be manually removed from Cluster 1 (834a) and reassigned to Cluster 2 (835), which corresponds to “Intent to retrieve pre-purchased tickets.”

At block 836, each labeled cluster may be associated with one or more actions, as per training block 736. For example, corresponding to “Intent to purchase tickets” (i.e., the label of Cluster 1), actions 836a, 836b, 836c may be associated.

FIG. 8C shows training 824 of machine classifier 624 using the plurality X of actionable statements (i.e., Actionable Statement 1 through Actionable Statement X) and corresponding labels (i.e., Label 1 through Label X), as per training block 740.

In an exemplary embodiment, user feedback may be used to further refine the performance of the methods and AI systems described herein. Referring back to FIG. 7, column 750 shows illustrative types of feedback that may be accommodated by method 700 to train machine classifier 624. Note the feedback types are shown for illustrative purposes only, and are not meant to limit the types of feedback that may be accommodated according to the present disclosure.

In particular, block 760 refers to a type of user feedback wherein the user indicates that one or more actionable statements identified by the AI system are actually not actionable statements, i.e., they do not contain grounded intent. For example, when presented with a set of actions that may be executed by AI system in response to user input, the user may choose an option stating that the identified statement actually did not constitute an actionable statement. In this case, such user feedback may be incorporated to adjust one or more parameters of block 720 during a training phase.

Block 762 refers to a type of user feedback, wherein one or more actions suggested by the AI system for an intent class does not represent the best action associated with that intent class. Alternatively, the user feedback may be that the suggested actions are not suitable for the intent class. For example, in response to prediction of user intent to prepare an expense report, an action associated action may be to launch a pre-configured spreadsheet application. Based on user feedback, alternative actions may instead be associated with the intent to prepare an expense report. For example, the user may explicitly choose to launch another preferred application, or implicitly reject the associated action by not subsequently engaging further with the suggested application.

In an exemplary embodiment, user feedback 762 may be accommodated during the training phase, by modifying block 736 of method 700 to associate the predicted intent class with other actions.

Block 764 refers to a type of user feedback, wherein the user indicates that the predicted intent class is in error. In an exemplary embodiment, the user may explicitly or implicitly indicate an alternative (actionable) intent underlying the identified actionable statement. For example, suppose the AI system predicts an intent class of “schedule meeting” for user input consisting of the statement “Let's talk about it next time.” Responsive to the AI system suggesting actions associated with the intent class “schedule appointment,” the user may provide feedback that a preferable intent class would be “set reminder.”

In an exemplary embodiment, user feedback 764 may be accommodated, during training of the machine classifier e.g., at block 732 of method 700. For example, an original verb-object pair extracted from an identified actionable statement may be reassigned to another cluster, corresponding to the preferred intent class indicated by the user feedback.

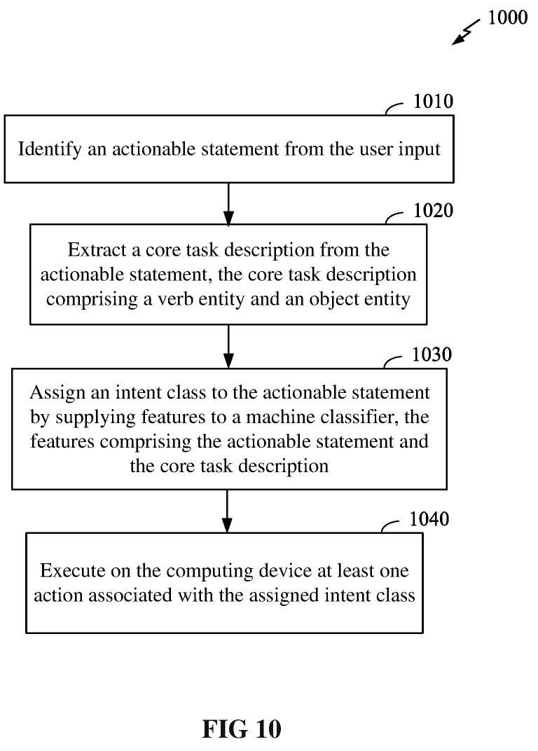

FIG. 10 illustrates an exemplary embodiment of a method 1000 for causing a computing device to digitally execute actions responsive to user input. Note FIG. 10 is shown for illustrative purposes only, and is not meant to limit the scope of the present disclosure.

In FIG. 10, at block 1010, an actionable statement is identified from the user input.

At block 1020, a core task description is extracted from the actionable statement. The core task description may comprise a verb entity and an object entity.

At block 1030, an intent class is assigned to the actionable statement by supplying features to a machine classifier, the features comprising the actionable statement and the core task description.

At block 1040, at least one action associated with the assigned intent class is executed on the computing device.

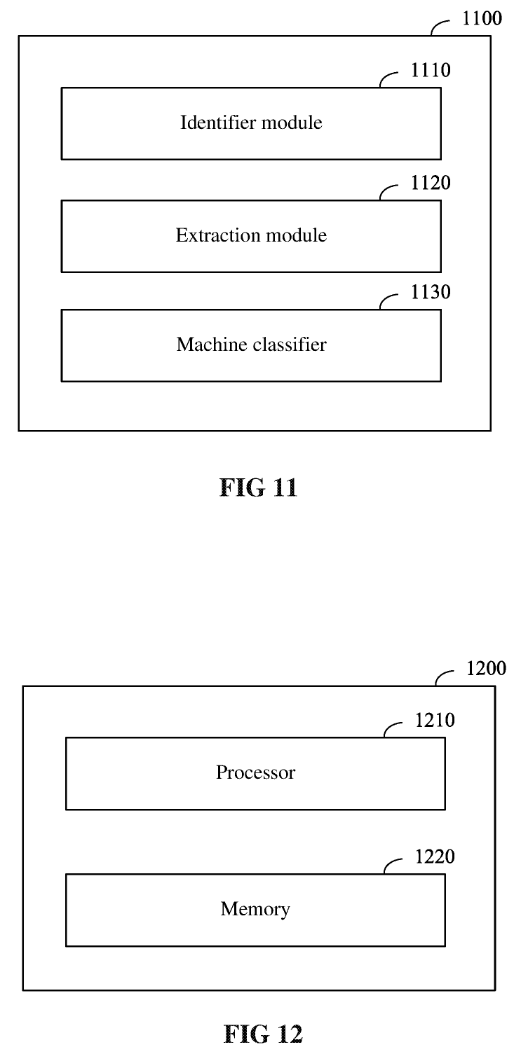

FIG. 11 illustrates an exemplary embodiment of an apparatus 1100 for digitally executing actions responsive to user input. The apparatus comprises an identifier module 1110 configured to identify an actionable statement from the user input; an extraction module 1120 configured to extract a core task description from the actionable statement, the core task description comprising a verb entity and an object entity; and a machine classifier 1130 configured to assign an intent class to the actionable statement based on features comprising the actionable statement and the core task description. The apparatus 1100 is configured to execute at least one action associated with the assigned intent class.

FIG. 12 illustrates an apparatus 1200 comprising a processor 1210 and a memory 1220 storing instructions executable by the processor to cause the processor to: identify an actionable statement from the user input; extract a core task description from the actionable statement, the core task description comprising a verb entity and an object entity; assign an intent class to the actionable statement by supplying features to a machine classifier, the features comprising the actionable statement and the core task description; and execute using the processor at least one action associated with the assigned intent class.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present. Furthermore, when an element is referred to as being “electrically coupled” to another element, it denotes that a path of low resistance is present between such elements, while when an element is referred to as being simply “coupled” to another element, there may or may not be a path of low resistance between such elements.

The functionality described herein can be performed, at least in part, by one or more hardware and/or software logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

1. A method for causing a computing device to digitally execute actions responsive to user input, the method comprising:
identifying an actionable statement from the user input;
extracting a core task description from the actionable statement, the core task description comprising a verb entity and an object entity;
assigning an intent class to the actionable statement by supplying features to a machine classifier, the features comprising the actionable statement and the core task description; and
executing on the computing device at least one action associated with the assigned intent class.

2. The method of claim 1, further comprising:
displaying the at least one action associated with the assigned intent class to the user; and
receiving user approval prior to executing the at least one action.

3. The method of claim 1, wherein the verb entity comprises at least one symbol from the actionable statement representing a task action, and the object entity comprises at least one symbol from the actionable statement representing an object to which the task action is applied.

4. The method of claim 1, the identifying the actionable statement comprising applying a commitments classifier or a request classifier to the user input.

5. The method of claim 1, the at least one action comprising launching an agent application on the computing device.

6. The method of claim 1, the features further comprising contextual features independent of the user input, the contextual features derived from prior usage of the device by a user or from parameters associated with a user profile or a cohort model.

7. The method of claim 1, further comprising training the machine classifier using weak supervision, the training comprising:
identifying a training statement from each of a plurality of corpus items;
extracting a training description from each of the training statements;
grouping the training descriptions by textual similarity into a plurality of clusters;
receiving an annotation of intent associated with each of the plurality of clusters; and
training the machine classifier to map each identified training statement to the corresponding annotated intent.

8. The method of claim 7, wherein the verb entity comprises a symbol from the corresponding training statement representing a task action, and the object entity comprises a symbol from the corresponding actionable statement representing an object to which the task action is applied. the grouping the training descriptions comprising:
grouping the training descriptions into a first set of clusters based on textual similarity of the corresponding object entities; and
refining the first set of clusters into a second set of clusters based on textual similarity of the corresponding verb entities.

9. The method of claim 7, further comprising:
receiving user feedback indicating rejection of the at least one action associated with the assigned intent class; and
training the machine classifier to map the actionable statement away from the assigned intent class.

10. The method of claim 7, further comprising:
receiving user feedback indicating acceptance of the at least one action associated with the assigned intent class; and
training the machine classifier to reinforce mapping further instances of the actionable statement to the assigned intent class.

11. The method of claim 7, further comprising:
receiving user feedback comprising at least one of subjective impression by the user of the quality or utility of the assigned intent class; and
training the machine classifier to map the actionable statement according to the received user feedback.

12. The method of claim 7, further comprising:
receiving user feedback comprising executing an alternative action distinct from the at least one action associated with the assigned intent class; and
associating the alternative action with the assigned intent class.

13. An apparatus for digitally executing actions responsive to user input, the apparatus comprising:
an identifier module configured to identify an actionable statement from the user input;
an extraction module configured to extract a core task description from the actionable statement, the core task description comprising a verb entity and an object entity; and
a machine classifier configured to assign an intent class to the actionable statement based on features comprising the actionable statement and the core task description;
the apparatus configured to execute at least one action associated with the assigned intent class.

14. The apparatus of claim 13, further configured to launch an agent application to execute the at least one action.

15. The apparatus of claim 13, further comprising a training module for training the machine classifier using weak supervision, the training module comprising:
a training identifier configured to identify a training statement from each of a plurality of corpus items;
a training extractor configured to extract a training description from each of the training statements;
a clustering module configured to group the training descriptions by textual similarity into a plurality of clusters; and
a manual adjustment module configured to receive an annotation of intent associated with each of the plurality of clusters;
the training module further configured to train the machine classifier to map each identified training statement to the corresponding annotated intent.

16. The apparatus of claim 15, wherein the verb entity comprises a symbol from the corresponding training statement representing a task action, and the object entity comprises a symbol from the corresponding actionable statement representing an object to which the task action is applied. the clustering module configured to group the training descriptions by:
grouping the training descriptions into a first set of clusters based on textual similarity of the corresponding object entities; and
refining the first set of clusters into a second set of clusters based on textual similarity of the corresponding verb entities.

17. The apparatus of claim 15, further comprising a feedback module configured to receive user feedback indicating rejection of the at least one action associated with the assigned intent class, the training module further configured to train the machine classifier to map the actionable statement away from the assigned intent class.

18. An apparatus comprising a processor and a memory storing instructions executable by the processor to cause the processor to:
identify an actionable statement from the user input;
extract a core task description from the actionable statement, the core task description comprising a verb entity and an object entity;
assign an intent class to the actionable statement by supplying features to a machine classifier, the features comprising the actionable statement and the core task description; and
execute using the processor at least one action associated with the assigned intent class.

19. The apparatus of claim 18, the memory further storing instructions to cause the processor to:
display the at least one action associated with the assigned intent class to the user; and
receive user approval prior to executing the at least one action.

20. The apparatus of claim 18, wherein the verb entity comprises at least one symbol from the actionable statement representing a task action, and the object entity comprises at least one symbol from the actionable statement representing an object to which the task action is applied.
